(19) United States
(12) Patent Application Publication
(10) Pub. No.: US 2017/0204888 A1
(43) Pub. Date: Jul. 20, 2017

(54) MULTIPART HOUSING MADE OF PLASTIC

(71) Applicant: Mahle International GmbH, Stuttgart (DE)

(72) Inventor: Klaus Voigt, Bietigheim-Bissingen (DE)

(21) Appl. No.: 15/408,403

(22) Filed: Jan. 17, 2017

(30) Foreign Application Priority Data
Jan. 18, 2016 (DE) 102016200568.5

(51) Int. Cl. F16B 5/06; B65D 6/00; B65D 6/24

(52) U.S. Cl. CPC F16B 5/0621; B65D 11/1866; B65D 11/20

(57) ABSTRACT

A multipart plastic housing may include a first plastic housing part and a second plastic housing part detachably securable to one another via at least one fastening device. The at least one fastening device may include a first bracket disposed integrally on the first housing part and a second bracket disposed integrally on the second housing part. The first bracket may include a boss for receiving a fastener and a clamp engaging member on which a clamp of a clamp closure is engageable. The second bracket may include a counter-bearing on which a head of the fastener is supported axially when the fastener is received in the boss and a lever bearing on which a lever of the clamp closure is supported when the clamp is engaged with the clamp engaging member. The clamp may be pivotably mounted on the lever.

### CROSS-REFERENCE TO RELATED APPLICATIONS

This application claims priority to German Patent Application DE-10 2016 200 568.5, filed on Jan. 18, 2016, which is hereby incorporated by reference in its entirety.

### TECHNICAL FIELD

The present invention relates to a multipart plastic housing, preferably for a use in a vehicle.

### BACKGROUND

Usually a housing comprises a housing interior in order to protect components accommodated therein. Such a housing can be configured to be multipart so that at least a first housing part and a second housing part are present which can be fastened to one another. As a result of the multipart nature of the housing, the housing interior is accessible as long as the housing parts are not fastened to one another. This can be used to accommodate the components in the housing. If these components are maintenance-free, the housing parts can be permanently and undetachably fastened to one another. However, if there is the risk that such a component must be replaced, it is expedient to fasten the housing parts detachably to one another. To this end there exist suitable fastening devices with the aid of which a detachable fastening of the two housing parts to one another can be achieved. Purely as an example, screw connections and clamp connections are mentioned here. Screw connections are characterized by being able to be achieved inexpensively so that they are particularly suitable for mass production. For inexpensive manufacture a suitable screw boss into which the respective screw can be screwed can be moulded on the relevant housing part made of plastic for the respective screw. However, such a screw boss is only suitable for screw connections which need to be opened relatively infrequently since the screw boss made of plastic is subjected to a high wear during each screwing process. Thus, a screw connection is only suitable for plastic housings when the plastic housing need not be opened or need only be opened very infrequently. In contrast to this, clamp connections can be released almost arbitrarily frequently and re-closed again. However, clamp connections have significantly higher manufacturing costs. Accordingly clamp connections are rather unsuitable for plastic housings which only infrequently need to be opened multiple times in order to produce these in large numbers.

### SUMMARY

The present invention is concerned with the problem of providing a simplified or at least a different embodiment for a plastic housing of the type described previously which is characterized by being inexpensive to manufacture and by an improved utility value. In particular, a method for an inexpensive manufacture should be indicated when the plastic housing need be opened multiple times only in relatively infrequent cases of application whereas in the vast majority of cases of application it need not be opened or need only be opened very infrequently.

This problem is solved according to the invention by the subject matter of the independent claim. Advantageous embodiments are the subject matter of the dependent claims.

The invention is based on the general idea of forming in each case integrally a first bracket on the first housing part and a second bracket on the second housing part to implement a fastening device. Furthermore, the first bracket and the second bracket are configured both for implementing a screw connection and also for implementing a clamp connection so that the two housing parts can be detachably fastened to one another by means of the respective fastening device with a screw connection or with a clamp connection as desired. In principle, it is also feasible to match the brackets to one another so that a screw connection and a clamp connection can even be implemented simultaneously. Since the housing parts and therefore the brackets formed integrally thereon consist of plastic, the housing parts with integrated brackets can be manufactured inexpensively by means of injection moulding. The housing presented here is therefore particularly suitable for mass production. If only an infrequent opening of the housing is now required for a first case of application or standard case, for example, in order to be able to replace the component in the event of a failure of a component accommodated in the housing, the housing can be provided with at least one screw connection in order to detachably fastened the housing parts to one another. This standard case can thus be implemented inexpensively in large numbers. If on the other hand the housing is to be configured for a second case of application or exceptional case such that it can be frequently, in particular arbitrarily frequently, opened and closed again, for example, in order to be able to carry out regular maintenance work for the components accommodated therein, the housing can be fitted with at least one clamp closure. Since the brackets are prepared both for implementing such a screw connection and also for such a clamp connection, this variant can also be implemented comparatively inexpensively for the exceptional case. Furthermore, it can even be provided that the clamp connection can be retrofitted so that each standard case can be retrofitted or converted into an exceptional case. In this case, for the first opening of the housing the respective screw connection is released whereas for the subsequent closure the clamp connection is then attached. For each further opening and closing process the clamp closure is then available. Likewise, in order to simplify the mass production it is feasible to initially fit all the housings with the screw connection in order to then additionally provide a clamp connection for the exceptional cases. During the first opening of the housing, the screw connection must then be released in addition to the clamp connection. During the renewed closing of the housing, however, the screw connection can then already be omitted so that during the subsequent opening of the housing only the clamp connection must be released.

In detail the invention proposes that the first bracket comprises a screw boss for screwing in a screw and a clamp engaging member on which a clamp of a clamp closure can engage. In contrast to this, the second bracket comprises a screw counter-bearing on which a head of the screw screwed into the screw boss can be supported axially and a lever bearing on which a lever of the clamp closure can be supported, the clamp being pivotably mounted on this lever. A variant in which the first bracket has the screw boss and the lever bearing whereas the second bracket has the screw counter-bearing and the clamp engaging member has the same effect and is equivalent to this. This variant can also be implemented similarly with the embodiments described hereinafter.

According to an advantageous embodiment, the screw counter-bearing has a through-opening for a shank of the screw which is in alignment with a screw opening of the screw boss when the first housing part is attached to the second housing part. Thus, a particularly efficient screw connection can be achieved.

It is preferably provided that the lever bearing is arranged on the second bracket on a side facing away from the first bracket. Additionally or alternatively the lever bearing can be externally concavely curved and defines a lever pivot axis about which the lever in the lever bearing is pivotably mounted when the clamp closure is mounted on the housing, in particular independently of whether the clamp closure is used for fixing the two housing parts to one another or not. Thus, the lever bearing defines a pivot bearing in which the lever can be rotated or pivoted about said pivot axis.

Expediently the screw counter-bearing can be arranged in the lever bearing. As a result, the second bracket has an extremely compact structure and requires little installation space on the second housing part. Particularly advantageous is a further development in which the screw counter-bearing is arranged recessed in the lever bearing. As a result of the recessed arrangement of the screw counter-bearing it is in particular possible to implement both the screw connection and the clamp connection on the same fastening device since the screw head recessed in the screw counter-bearing does not impede the pivotability of the lever in the lever bearing.

In another embodiment, a bearing end of the lever inserted in the lever bearing can cover the screw counter-bearing. This has the result that when the lever is inserted in the lever bearing, the screw head is no longer accessible. If both a screw connection and also a clamp connection are provided, the clamp closure thereby brings about a securing of the screw connection. Of primary importance however is the advantage that as a result of this design, the second bracket can have an extremely compact structure so that the second bracket requires little installation space on the second housing part.

It can advantageously be provided that the clamp engaging member defines a recess in the first bracket on a side facing away from the second bracket in which the clamp can engage positively when the clamp closure is attached to the housing and is used for fastening the two housing parts to one another.

In another embodiment a clip end of the clamp engaging in the clamp engaging member overlaps the screw boss. In particular the screw boss can in this case form at least a part of the clamp engaging member and be used for positive securing of the clip end. This measure also results in a compact design of the first bracket so that the first bracket also only requires a little installation space on the first housing part.

An embodiment is advantageous in which the screw boss is arranged centrally with respect to the clamp engaging member in relation to a lever pivot axis about which the lever is pivotally mounted in the lever bearing. This results in an extremely compact structure for the first bracket.

Additionally or alternatively, the screw counter-bearing can be arranged centrally with respect to the lever bearing in relation to a lever pivot axis about which the lever is pivotally mounted in the lever bearing. This results in an extremely compact design for the second bracket.

According to another advantageous embodiment, the second bracket can have a latching device which secures the lever on the second bracket and which engages during insertion of a bearing end of the lever into the lever bearing. By attaching the lever to the second bracket, i.e. during insertion of the bearing end into the lever bearing, the latching device brings about a locking or an engagement of the bearing end in the lever bearing. Consequently, the lever can then no longer be withdrawn from the lever bearing or only with significantly increased force transversely to the lever pivot axis. Thus, the lever and therefore the entire clamp closure is held captively on the second bracket. The clamp closure can thus be attached captively on the housing independently of whether it is used for fastening the two housing parts to one another or not. In particular, in this way it can be provided quasi-redundantly on the housing as long as the fastening of the two housing parts to one another is made with the respective screw. It can then be used additionally to the screw or alternatively to the screw for fastening the two housing parts to one another if the screw is lost or the thread in the screw boss has become unusable.

In another advantageous embodiment, the first bracket has a preferably flat first stop facing the second bracket. Additionally or alternatively the second bracket can have an, in particular flat, second stop facing the first bracket. Expediently it can now be provided that when the second housing part is fastened on the first housing part, the first stop is supported on the second stop where in particular a flat abutment of the two stops against one another is obtained. As a result of this direct contact of the two brackets against one another, comparatively high forces can be transmitted between the brackets within the respective fastening device in order to ensure an efficient fastening of the two housing parts on one another.

In an advantageous further development, the first stop and the second stop can lie in a parting plane in which the first housing part and the second housing part abut against one another. This design makes assembly easier.

In another embodiment which in particular assumes that the fastening device is fitted with the clamp closure, the lever can comprise a manually actuatable grip end and a bearing end mounted pivotably about a lever pivot axis in the lever bearing where the clamp is mounted pivotably about a clamp pivot axis which extends parallel to the lever pivot axis between the bearing end and the grip end. Thus, the clamp closure preferably only consists of two components, namely of the lever and the clamp mounted thereon. Thus, the clamp connection which can be achieved here is characterized by a particularly simple structure which is therefore inexpensive to implement. It is worth noting that the clamp connection is formed by the clamp engaging member, the lever bearing and the clamp closure where the clamp closure comprises the lever and the clamp for this purpose. The screw connection is formed by the screw boss, the screw counter-bearing and the screw.

In another embodiment which in particular assumes that the fastening device is fitted with the clamp closure, the clamp closure can be adjustable between a closed position and an open position by pivoting the lever about a lever pivot axis in the lever bearing, wherein the individual components of the clamp connection are matched to one another so that the clamp closure adopts a dead centre position in the closed position. This secures the clamp closure against independent opening. The dead centre position is characterized in that a plane in which a clamp pivot axis and a clip axis lie, extends between a lever pivot axis and a housing interior. The clamp pivot axis is thereby formed by the axis about which the clamp is pivotably mounted on the lever. The clip axis is thereby formed by that axis in which a clip end of the clamp engaging in the clamp engaging member extends. The lever pivot axis is formed by that axis about which the lever inserted in the lever bearing is pivotably mounted. The housing interior is that space which is enclosed by the housing in the region of the brackets. In other words, in the dead point position the lever pivot axis is located on a side of the said plane facing away from the housing interior. During pivoting of the lever, the clamp pivot axis is pivoted about the lever pivot axis. At the same time, the aforesaid plane thus pivots about the clip axis. Consequently the lever pivot axis traverses the said plane and then lies in the open position of the clamp closure on the side of the said plane facing the housing interior. This kinematics has the result that for transferring the clamp closure from the closed position into the open position, the clamp must be stretched resiliently so that a closing force of the clamp by means of which the clamp biases the lever into the closed position must be overcome.

In another advantageous embodiment, the first housing part can have an opening edge which borders a housing opening which is closed by the second housing part when the second housing part is attached to the first housing part. Expediently the first housing part can now have a groove in this opening edge in which a tongue complementary thereto, formed integrally on the second housing part engages when the second housing part is attached to the first housing part. This results in a predetermined positioning between the two housing parts when these are attached to one another in order to simplify the fastening of the two housing parts to one another with the aid of the respective fastening device. At the same time, such a groove-tongue connection brings about a certain sealing of the housing, i.e. a sealing of the housing interior with respect to a housing environment. It is clear that in principle in an alternative embodiment the second housing part can have an opening edge with a groove whereas the first housing part then has a complementary tongue engaging therein.

According to another advantageous embodiment, it can be provided that when the second housing part is attached to the first housing part in the respective fastening device, the screw is screwed into the screw boss of the first bracket and is supported with its head on the screw counter-bearing of the second bracket. Additionally or alternatively when the second housing part is fastened to the first housing part, the clamp closure is adjusted into its closed position in which the clamp engages in the clamp engaging member of the first bracket and the lever is supported on the lever bearing of the second bracket. In other words, when the fastening device is active for fastening the two housing parts to one another, either the screw connection or the clamp connection is used. Likewise it can be provided that both the screw connection and also the clamp connection are used. Accordingly the respective fastening device is fitted with the screw and/or with the clamp closure.

Further important features and advantages of the invention are obtained from the subclaims, from the drawings and from the relevant description of the figures by reference to the drawings.

It is understood that the aforesaid features and those still to be explained can be used not only in the respectively given combination but also in other combinations or alone without departing from the framework of the present invention.

Preferred exemplary embodiments of the invention are presented in the drawings and will be explained in detail in the following description where the same reference numbers relate to the same or similar or functionally the same components.

### BRIEF DESCRIPTION OF THE DRAWINGS

In the figures, in each case schematically,

FIG. 1 shows an exploded isometric view of a plastic housing with a plurality of fastening devices,

FIG. 2 shows an isometric view of the plastic housing in the region of a fastening device with a clamp connection,

FIG. 3 shows an isometric view of the fastening device with a screw connection,

FIG. 4 shows an isometric view of a clamp closure of the clamp connection,

FIG. 5A shows a highly simplified schematic view of the clamp closure to illustrate a closed position,

FIG. 5B shows a highly simplified schematic view of the clamp closure to illustrate an open position.

### DETAILED DESCRIPTION

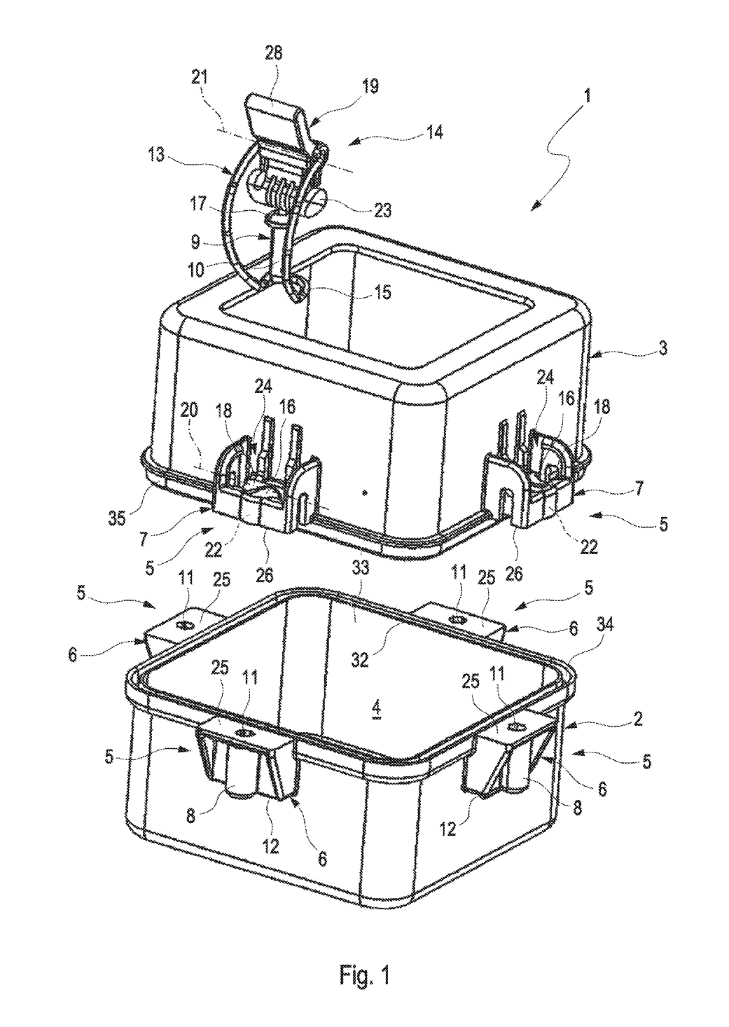

According to FIG. 1, a multipart plastic housing 1 comprises a first housing part 2 and a second housing part 3. First housing part 2 and second housing part 3 are each made of plastic, for example by means of injection moulding. In the example shown, the plastic housing 1 consists of these two housing parts 2, 3. The housing 1 encloses a housing interior 4 in which at least one, quasi-arbitrary component can be accommodated. The housing interior 4 is closed by fastening the two housing parts 2, 3 to one another. It is usually no longer accessible as a result. The housing interior 4 is only accessible again when the housing 1 is opened. Opening of the housing 1 is accomplished by removing the second housing part 3 from the first housing part 2 and/or conversely.

The housing 1 additionally has at least one fastening device 5 with the aid of which the two housing parts 2, 3 can be detachably fastened to one another. In the example of FIG. 1 precisely four such fastening devices 5 are provided which are arranged distributed on four sides of the overall quadrangular housing 1.

The respective fastening device 5 comprises according to FIGS. 1 to 3 in each case a first bracket 6 and a second bracket 7. The first bracket 6 is integrally formed on the first housing part 2, is therefore already formed thereon during the injection moulding of the first housing part 2. The second bracket 7 is formed integrally on the second housing part 3 and is accordingly formed in one piece or composed of a single material thereon during manufacture of the second housing part 3.

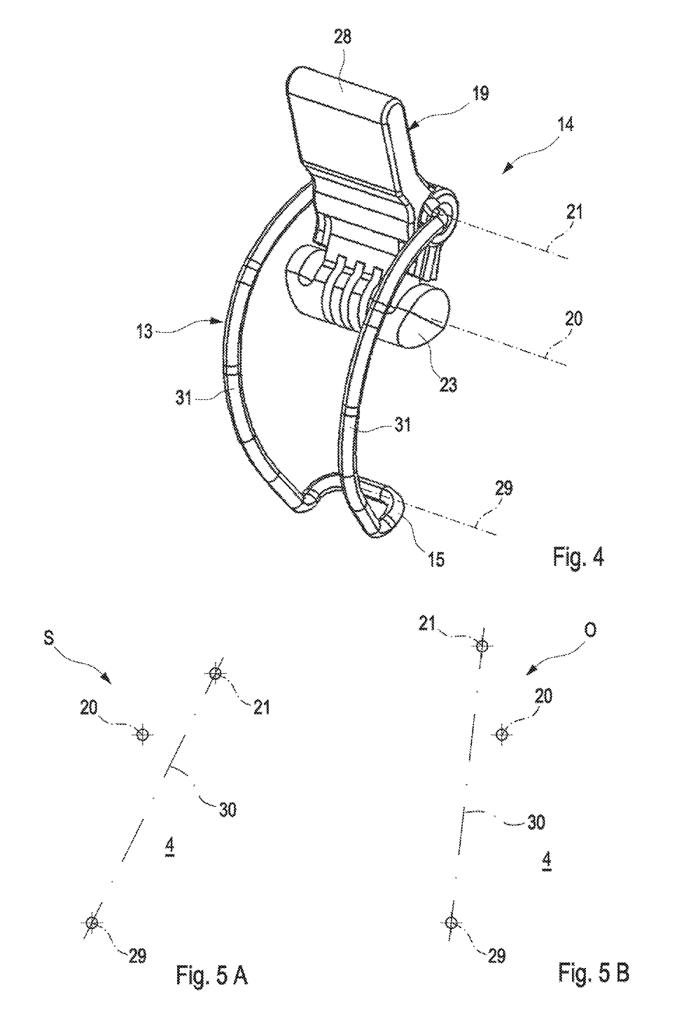

The first bracket 6 has a screw boss 8 into which a screw 9 identifiable in FIGS. 1 and 3 can be screwed. In so doing, a shank 10 of the screw 9 engages in a screw opening 11 which is formed in the screw boss 8. Furthermore, the first bracket 6 has a clamp engaging member 12 on which a clamp 13 of a clamp closure 14 shown in FIGS. 1, 2 and 4 can engage. To this end the clamp 13 has a clip end 15 which cooperates with the clamp engaging member 12 to fix the clamp 13 on the first bracket 6. It can be seen that the clamp engaging member 12 can define a recess in the first bracket 6 on a side facing away from the second bracket 7, in which the clamp 13 can engage positively.

The second bracket 7 has a screw counter-bearing 16 on which a head 17 of the screw 9 can be supported axially. Furthermore, the second bracket 7 has a lever bearing 18 in which a lever 19 of the clamp closure 14 can be supported pivotably about a lever pivot axis 20. On this lever 19 the clamp 13 is mounted pivotably about a clamp pivot axis 21. Expediently the lever bearing 18 is curved concavely outwards for this purpose in such a manner that it defines the lever pivot axis 20 about which the lever 19 inserted therein is pivotably mounted in the lever bearing 18.

The screw counter-bearing 16 has a through-opening 22 for the shank 10 of the screw 9, which is covered in the figures. This through opening 22 is aligned axially to the screw opening 11 of the screw boss 8 when the first housing part 2 and the second housing part 3 are placed correctly on one another. For screwing the screw 9 with its shank 10 is passed through the through opening 22 and screwed into the screw opening 11.

The screw counter-bearing 16 is arranged in the lever bearing 18 and specifically recessed, which can be deduced in particular from FIG. 3. The recessed arrangement of the screw counter-bearing 16 in the lever bearing 18 can be designed according to FIG. 3 so that the screw head 17 is arranged completely recessed in the lever bearing 18. Consequently the lever 19 can then also be attached to the second bracket 7 when the screw 9 is inserted. A bearing end 23 of the lever 19 inserted in the lever bearing 18 then covers the screw counter-bearing 16 and optionally the screw head 17. The clamp engaging member 12 is arranged on a side of the screw boss 8 facing the housing interior 4 so that the clip end 15 of the clamp 13 overlaps the screw boss 8 when this is in engagement with the clamp engaging member 12. In particular, the screw boss 8 can thereby form a component of the clamp engaging member 12 on its side facing the housing interior 4.

As can be deduced from FIGS. 1 to 3 in particular, the screw boss 8 is arranged centrally to the clamp engaging member 12 on the first bracket 6 in relation to the lever pivot axis 20. Furthermore the screw counter-bearing 16 is arranged centrally to the lever bearing 18 on the second bracket 7 in relation to the lever pivot axis 20. This results in a compact integration of the elements required to implement a screw connection within the elements required to implement a clamp connection.

The second bracket 7 can additionally be fitted with a latching device 24 which secures the lever 19 on the second bracket 7. To this end the latching device 24 cooperates with the bearing end 23. The latching device 24 is thereby configured and matched to the bearing end 23 so that the latching connection is made when inserting the bearing end 23 into the lever bearing 18. In other words, locking takes place when inserting the bearing end 23 into the lever bearing 18. The lever 19 and therefore the entire clamp closure 14 is thus held captive on the second bracket 7.

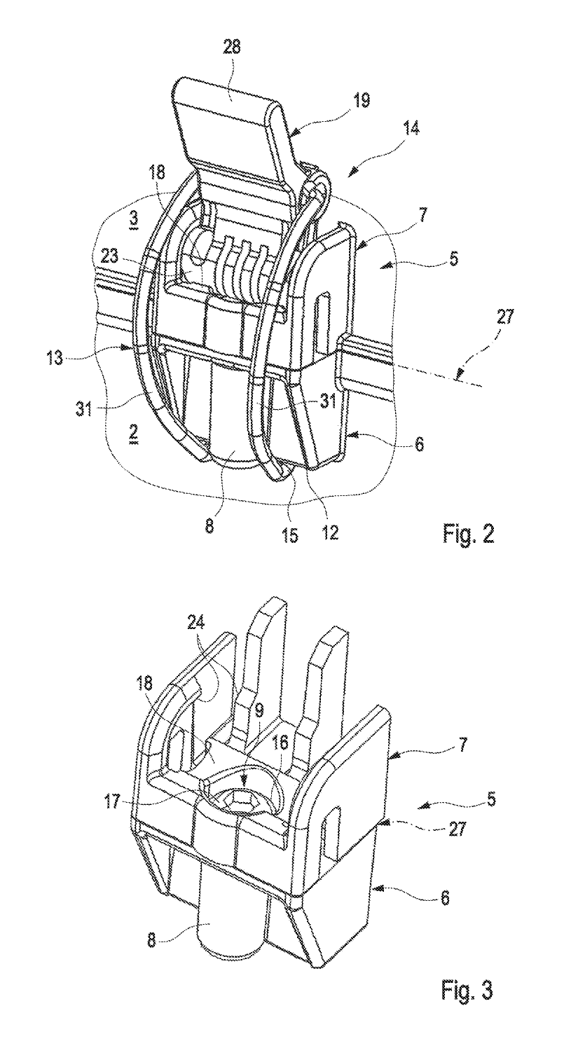

According to FIGS. 1 to 3, the first bracket 6 has a flat first stop 25 facing the second bracket 7. The second bracket 7 has a flat second stop 26 facing the first bracket 6. The stops 25, 26 are matched to one another so that the first stop 25 is supported flat on the second stop 26 when the two housing parts 2, 3 abut against one another or are fastened to one another. In particular, it can thereby be provided that the two stops 25, 26 in the assembled state lie in a parting plane 27 indicated in FIGS. 2 and 3 in which the two housing parts 2, 3 abut against one another.

As can be deduced from FIGS. 1, 2 and 4, the lever 19 has a manually actuatable grip end 28 and the bearing end 23 cooperating with the lever bearing 18. The clamp 13 is now mounted pivotably about the clamp pivot axis 21 between the bearing end 23 and the grip end 28 on the lever 19. The clamp pivot axis 21 thereby extends parallel to the lever pivot axis 20. The clamp closure 14 is adjustable by pivoting the lever 19 about the lever pivot axis 20 between a closed position S indicated in FIG. 5A and an open position O indicated in FIG. 5B. In the closed position S the clamp closure 14 adopts a dead point position. In FIGS. 5A and 5B the lever pivot axis 20, the clamp pivot axis 21 and the clip axis 29 are reproduced in a simplified manner. The clip axis 29 is defined by the clip end 15 of the clamp 13 cooperating with the clamp engaging member 12. This clip end 15 extends in the clamp engaging member 12 in said clip axis 29. The clamp pivot axis 21 and the clip axis 29 define a plane 30 in which the clamp pivot axis 21 and the clip axis 29 run. The dead point position of the closed position S is characterized in that this plane 30 in which the clamp pivot axis 21 and the clip axis 29 lie extends between the lever pivot axis 20 and the housing interior 4. In the open position O according to FIG. 5B on the other hand, the lever pivot axis 20 is arranged between the housing interior 4 and said plane 30. The dead point position is stable since in order to move the clamp closure 14 from the dead point position, i.e. out from the closed position S the distance between clamp pivot axis 21 and clip axis 29 must be increased. This can only be accomplished against the spring force of the clamp 13. The spring force of the clamp 13 is here produced by a bent spring section 31 of the clamp 13.

In the example in FIG. 1 the first housing part 2 has an opening edge 32 which borders a housing opening 33 through which the housing interior 4, at least the area of the housing interior 4 lying in the first housing part 2 is accessible. When the second housing part 3 is attached to the first housing part 2, the housing opening 33 is closed by the second housing part 3. In the example in FIG. 1 the first housing part 2 is now fitted with a closed circumferential groove 34 in its opening edge 32. Complementary to this, the second housing part 3 has a closed circumferential tongue 35 which is formed integrally on the second housing part 3. When the second housing part 3 is placed on the first housing part 2, the tongue 35 engages positively in the groove 34. According to an advantageous embodiment, the tongue 35 can be made of a sealing material. It can be foamed or injection moulded onto the plastic of the second housing part 3. Alternatively to this a separate seal can be inserted in the groove 34. It is also feasible to inject or foam a seal into the groove 34.

The two housing parts 2, 3 can be fastened detachably to one another with the aid of the respective fastening device 5 therefore either with the aid of the respective screw 9 or with the aid of the respective clamp closure 14. Whereas the screw connection can only be opened a few times, the clamp connection can be opened and closed frequently. In the example shown here the clamp connection can be retrofitted since the clamp closure 14 can easily be attached subsequently to the second bracket 7. In principle, an embodiment is also feasible in which both the screw 9 and also the clamp closure 14 are used. For example, in the course of a mass production all the housings 1 can be closed by means of screws 9 in order to provide these for the usual cases of application where only a small number of the housings 1 produced is additionally fitted with the clamp closures 14 in order to provide these for special cases of application.

1. A multipart plastic housing, comprising:
a first plastic housing part and a second plastic housing part detachably securable to one another via at least one fastening device;
at least one fastening device including a first bracket disposed integrally on the first housing part and a second bracket disposed integrally on the second housing part;
the first bracket including a boss for receiving a fastener and a clamp engaging member on which a clamp of a clamp closure is engageable; and
the second bracket including a counter-bearing on which a head of the fastener is supported axially when the fastener is received in the boss and a lever bearing on which a lever of the clamp closure is supported when the clamp is engaged with the clamp engaging member, wherein the clamp is pivotably mounted on the lever.

2. The housing according to claim 1, wherein the counter-bearing has a through-opening for a shank of the fastener, and wherein the through-opening is aligned with an opening of the boss when the first housing part is attached to the second housing part.

3. The housing according to claim 1, wherein the lever bearing is externally concavely curved and defines a lever pivot axis about which the lever in the lever bearing is pivotably mounted.

4. The housing according to claim 1, wherein the counter-bearing is arranged in the lever bearing.

5. The housing according to claim 1, wherein the lever has a bearing end inserted in the lever bearing which covers the screw counter-bearing.

6. The housing according to claim 1, wherein the clamp has a clip end engaged in the clamp engaging member and overlapping the boss when the first bracket is coupled to the second bracket.

7. The housing according to claim 1, wherein the boss is arranged centrally with respect to the clamp engaging member in relation to a lever pivot axis about which the lever is pivotally mounted in the lever bearing.

8. The housing according to claim 1, wherein the counter-bearing is arranged centrally with respect to the lever bearing in relation to a lever pivot axis about which the lever is pivotally mounted in the lever bearing.

9. The housing according to claim 1, wherein the second bracket includes a latching device securing the lever on the second bracket, wherein the latching device engages the lever when a bearing end of the lever is inserted into the lever bearing.

10. The housing according to claim 1, wherein:
the first bracket has a first stop facing the second bracket;
the second bracket has a second stop facing the first bracket; and
the first stop is supported on the second stop when the first housing part and the second housing part are attached to one another.

11. The housing according to claim 10, wherein the first stop and the second stop lie in a parting plane in which the first housing part and the second housing part abut against one another.

12. The housing according to claim 1, wherein:
the at least one fastening device includes the clamp closure;
the lever of the clamp closure includes a manually actuatable grip end and a bearing end mounted pivotably about a lever pivot axis in the lever bearing; and
the clamp is mounted pivotably on the lever about a clamp pivot axis which extends parallel to the lever pivot axis between the bearing end and the grip end.

13. The housing according to claim 1, wherein:
the at least one fastening device includes the clamp closure;
the clamp closure is adjustable between a closed position and an open position by pivoting the lever about a lever pivot axis in the lever bearing; and
the clamp closure is disposed in a dead centre position in the closed position.

14. The housing according to claim 1, wherein:
the first housing part includes an opening edge which borders a housing opening, wherein the housing opening is closed by the second housing part when the second housing part is attached to the first housing part;
the first housing part further includes a groove disposed in the opening edge; and
the second housing part includes a tongue arranged complementary to the groove, wherein the tongue engages into the groove when the second housing part is attached to the first housing part.

15. The housing according to claim 1, wherein the at least one fastening device includes the fastener, and when the second housing part is attached to the first housing part by the at least one fastening device, the fastener is received in the boss of the first bracket and is supported with via the head on the counter-bearing of the second bracket.

16. The housing according to claim 15, wherein the at least one fastening device further includes the clamp closure, and when the second housing part is attached to the first housing part by the at least one fastening device, the clamp closure is adjusted into a closed position in which the clamp engages in the clamp engaging member of the first bracket and the lever is supported on the lever bearing of the second bracket.

17. The housing according to claim 1, wherein the at least one fastening device includes the clamp closure, and when the second housing part is attached to the first housing part by the at least one fastening device, the clamp closure is adjusted into a closed position in which the clamp engages in the clamp engaging member of the first bracket and the lever is supported on the lever bearing of the second bracket.

18. The housing according to claim 1, wherein the clamp engaging member defines a recess in the first bracket on a side facing away from the second bracket in which the clamp is engageable.

19. The housing according to claim 7, wherein the counter-bearing is arranged centrally with respect to the lever bearing in relation to the lever pivot axis about which the lever is pivotally mounted in the lever bearing.

20. A multipart plastic housing, comprising:
a first plastic housing part and a second plastic housing part;
at least one fastening device structured to attach the first housing part and the second housing part together;
the at least one fastening device including a first bracket disposed integrally on the first housing part, a second bracket disposed integrally on the second housing part, and a clamp closure including a clamp pivotally mounted on a lever;
the first bracket including a boss for receiving a fastener and a clamp engaging member on which the clamp of the clamp closure engages when the first housing part and the second housing part are attached together;
the second bracket including a counter-bearing on which a head of the fastener is supported axially when the fastener is received in the boss and a lever bearing on which the lever of the clamp closure is supported when the clamp is engaged with the clamp engaging member; and
wherein the counter-bearing is arranged recessed in the lever bearing.
